(19) United States
(12) Patent Application Publication
(10) Pub. No.: US 2008/0280192 A1
(43) Pub. Date: Nov. 13, 2008

(54) BATTERY THERMAL MANAGEMENT SYSTEM

(75) Inventors: Piotr Drozdz, Vancouver (CA); Lorne Edward Gettel, Vancouver (CA); Dale Kevin Brown, Vancouver (CA); Stewart Neil Simmonds, Coquitlam (CA)

Correspondence Address: SEED INTELLECTUAL PROPERTY LAW GROUP PLLC, 701 FIFTH AVE, SUITE 5400, SEATTLE, WA, 98104, US

(73) Assignee: ADVANCED LITHIUM POWER INC., Vancouver (CA)

(21) Appl. No.: 12/029,154

(22) Filed: Feb. 11, 2008

Related U.S. Application Data
(60) Provisional application No. 60/900,334, filed on Feb. 9, 2007.

(51) Int. Cl. H01M 10/50; G05D 23/00

(52) U.S. Cl. 429/62; 429/120; 700/297

(57) ABSTRACT

Disclosed herein is a battery thermal management system for maintaining the temperature of a battery pack in a hybrid vehicle below a maximum operating temperature threshold. The system comprises a battery pack having a plurality of electronically linked cells and a supply air diffuser having a pattern of openings therein for diffusing exhausted air at a substantially uniform flow throughout the battery pack. The system further comprises sensors for monitoring the temperature of at least a portion of the cells, a fan comprising an inlet through which air is drawn in and an outlet in communication with at least the supply air diffuser, for exhausting air into the first diffuser to lower the temperature of the battery pack, and an electronic control unit in communication with the sensors and the fan for controlling operation of the fan based on temperature signals received from the sensors to maintain the temperature of the battery pack below a maximum operating temperature.

### FIELD OF THE INVENTION

The invention relates generally to energy storage, and particularly to thermal management of batteries.

### BACKGROUND

Electrochemical batteries generate heat due to electrical resistance and internal electrochemical processes. In most cases, battery packs do not need active thermal management as the heat is dissipated by natural convection and radiation.

An extreme application for electrochemical batteries is an engine-dominant hybrid electric vehicle powertrain. The engine-dominant hybrid system, also known as a self-sustaining hybrid system or full hybrid system, consists of a relatively large internal combustion engine, one or more electric machines that can operate as motors or generators, and a relatively small battery pack. Because the battery pack in such a system should be as small as possible due to cost, weight and packaging constraints, however, it experiences repetitive high loads relative to its size. For instance, typical peak loads for a 6 Ah hybrid car battery may exceed 150 A during acceleration and 60 A during regenerative braking charge. That represents repetitive 25C discharge and 10 C charge loads, where C is an industry measure of discharge/charge rate equivalent to the current required to completely discharge/charge the battery in one hour.

Depending on the duty cycle, the heat from a charge-discharge cycle of the battery can build up and cause the battery to overheat. Certain types of batteries exhibit a thermal runaway phenomenon where the heat generation increases rapidly with the temperature leading to battery failure or even destruction. Thus batteries and battery packs without adequate cooling will fail to maintain the temperature of cells within the optimum operating limits. With the exception of high temperature battery technologies, the batteries used in electric and hybrid electric vehicle drives should be operated in moderate temperatures, ideally within the 10-30° C. range to ensure performance, efficiency and durability. Additionally, in extremely cold environments, battery heating must be provided.

A particularly important aspect of the hybrid vehicle application is the battery life requirement of 8 to 10 years. Typically, in consumer applications, the battery life is up to 4 years for products such as cellular phones and computers. One of the factors known to affect battery life is temperature. Operation in elevated temperatures, for example above 40° C., significantly reduces the lifetime number of charge-discharge cycles a battery is capable of. Another critical factor in achieving long battery life is a uniform temperature distribution across the battery pack. In a battery pack comprising a large number of cells, all cells should be maintained at a substantially uniform temperature. If the battery pack temperature is not uniform, the cells with higher temperature deteriorate faster and ultimately fail. In pack configurations with a large number of cells arranged in series, failure of a single cell results in the whole pack failing.

As hybrid vehicles can operate in a variety of climates, low temperature performance is an important requirement for traction and energy losses during operation are sufficient to maintain the battery within the desired temperature range. However, in extremely cold climates, battery heating must be provided, particularly if the battery is exposed to long periods in a low temperature environment, for example in a parked vehicle.

Hybrid vehicles utilize air cooling to prevent the battery pack from overheating. Air cooling is a simple and cost effective solution that is adequate for series-parallel configurations where the battery load can be controlled by increasing or decreasing the engine contribution to the motive power demand. The disadvantages of air cooling are its limited effectiveness at higher thermal loads and difficulty in achieving uniform temperature distribution.

In series hybrid configurations, the battery load can be higher, particularly for heavier vehicles, and liquid cooling may be used. Liquid cooling is more effective and can provide a more uniform battery pack temperature than air cooling. However, liquid cooling systems are more complex and much heavier than air cooling systems and therefore consume more energy in transit.

A need therefore exists to provide a battery thermal management system, method or device that provides a solution to at least some of the deficiencies in the prior art.

### SUMMARY

According to one aspect of the invention, there is provided a battery thermal management system for managing the temperature of a battery pack in a hybrid vehicle. The system comprises a battery pack; a fan having an air outlet; and a plenum having an inlet in fluid communication with the fan air outlet and a supply air diffuser in fluid communication with the battery pack. The supply air diffuser has openings configured to deliver a substantially uniform air flow across the battery pack from an air flow supplied by the fan to the plenum.

The plenum can also have at least one baffle extending from the fan air outlet and across the supply air diffuser in such a configuration that the plenum is divided into multiple sections receiving substantially equal air flux from the fan. The diffuser openings can be slots of increasing size with increasing distance from the fan air outlet. Alternatively, the diffuser openings can be holes with one or both of increasing density and increasing size with increasing distance from the fan air outlet. The fan outlet can have a rectangular cross-section, and there can be multiple baffles in which case the leading edges of the baffles are concentrated around the centre of the fan air outlet. In particular, the system can comprise three baffles per fan air outlet, wherein a centre baffle is straight and has a leading edge at the centre of the fan outlet and the other two baffles are respectively located on either side of the centre baffle and each have a trailing edge that curves away from the centre baffle.

The system can further comprise a discharge air diffuser having openings in fluid communication with the battery pack. The supply air diffuser and discharge air diffuser are spaced from each other to form a battery compartment therebetween, and the battery pack is located inside the battery compartment. The discharge air diffuser can have openings which are slots of increasing size with increasing distance away from the fan air outlet. Alternatively, the discharge air diffuser openings can be holes with one or both of increasing density and increasing size with increasing distance away from the fan air outlet.

The battery pack can comprise of a plurality of modules and temperature and current sensors. Each module comprises a plurality of electronically linked cells wherein the temperature of at least one cell from each module is monitored by the sensors. The battery thermal management system can further comprise a cell management board (CMB) communicative with the sensors, and an electronic control unit communicative with the CMB and the fan and operable to control the operation of the fan based on temperature and current data received from the CMB. The electronic control unit can have a memory having code recorded thereon for execution by the control unit. The code comprises a map of a typical cell temperature distribution encoded thereon, a step for comparing temperatures measured by the sensors with temperatures in the map, and a step for generating a warning message when the measured temperatures differ by a selected threshold from the temperatures in the map.

The system can further comprise power contactors electrically connected to the battery pack and for electrically connecting to a vehicle motor controller. In such case, the electronic control unit is communicative with the power contactors and the code includes a step for opening the power contactors when temperature measured by the sensors exceeds a selected threshold.

The system can further comprise a heater in communication with the electronic control unit. In such case, the code includes a minimum battery pack temperature threshold, and a step for activating the heater to maintain the temperature of the battery pack above the minimum battery pack temperature threshold based on the temperature signals received from the sensors.

According to another aspect of the invention, there is provided a computer readable memory having recorded thereon code for execution by an electronic control unit of a battery thermal management system, to carry out a method comprising: measuring the temperature of at least one module of a battery pack; and when the measured temperature is within a predefined range and increasing, reducing charge and discharging power limit of the battery pack by a prescribed amount. The method can also comprise: when the measured temperature is steady or decreasing, comparing the measured temperature of multiple modules of the battery pack with temperatures in a map of a typical cell temperature distribution, and generating a warning message when the measured temperatures differ by a selected threshold from the temperatures in the map. Also, the method can further comprise opening a power contactor electrically connected to the battery pack and when also electrically connected to a vehicle motor controller when closed, when the measured temperature exceeds the predefined range. Also, the method can further comprise activating a battery heater when the measured temperature falls below the predefined range.

Also, the method can further comprise: reading a state of charge and battery current of a battery cell in the battery pack; determining a battery internal resistance and heat generated or absorbed by the battery cell due to enthalpy change, calculating heat Q generated by the battery cell according to formula:

Q=I²*R+Qₑ,

wherein: I=battery current;

R=battery internal resistance; and

measuring ambient temperature; calculating battery heat loss at the ambient temperature; and integrating the battery heat loss at periodic intervals and setting a fan at a selected speed when the integrated battery heat loss is greater than 0, and turning off the fan when the integrated battery heat loss is less than 0, the fan being in air communication with the battery pack.

Other features and advantages of the present disclosure will be set forth, in part, in the descriptions which follow and the accompanying drawings, wherein preferred embodiments and some exemplary implementations of the present invention are described and shown, and in part, will become apparent to those skilled in the art upon examination of the following detailed description taken in conjunction with the accompanying drawings or may be learned by practice of the present invention. The advantages of the present invention may be realized and attained by means of the instrumentalities and combinations of elements and instrumentalities particularly pointed out in the appended claims. dr

### BRIEF DESCRIPTION OF THE SEVERAL VIEWS OF THE DRAWINGS

FIG. 1 is an illustrative isometric front view of a battery module used in a battery thermal management system according to one embodiment of the invention;

FIG. 2a is an illustrative isometric rear view of the battery module having a printed circuit board (PCB) in partially exploded view;

FIG. 2b is an illustrative top plan view of the battery module with its top panel removed;

FIG. 3 is an illustrative isometric view of multiple battery modules arranged to form a battery bank;

FIG. 4 is an illustrative isometric rear view of multiple banks arranged to form a battery assembly;

FIG. 5a is an illustrative isometric rear view of a fan mounting of the battery thermal management system according to one embodiment of the invention;

FIG. 5b is an illustrative isometric rear view of the fan mounting mounted to the battery assembly;

FIG. 6 is an illustrative side view of the battery assembly in a battery enclosure and lid, and with arrows indicating an airflow path therethrough;

FIG. 7a is an illustrative isometric bottom view of the battery assembly and certain parts of the battery thermal management system;

FIG. 7b is a bottom view of the battery thermal management system with arrows illustrating the airflow path therethrough;

FIG. 8 is an airflow distribution graph illustrating a velocity distribution across a fan outlet of the battery thermal management system and a total integrated air flow volume as a function of the distance from one edge of the fan outlet;

FIG. 9 is a baffle design graph illustrating a baffle shape in an x-y coordinate system and a resulting flow area graph as a function of fan outlet width of the battery thermal management system;

FIG. 10 is a cell resistive heat graph illustrating a resistive heat loss by a cell as a function of discharge current of the battery thermal management system;

FIG. 11 is a flow chart showing a battery control module (BCM) logic used to implement the temperature limits according to one embodiment of the present invention; and

FIG. 12 is a flow chart showing BCM logic used to implement the temperature limits according to another embodiment of the present invention.

FIG. 13 is a flow chart showing BCM logic used to control the air flow according to yet another embodiment of the invention.

### DETAILED DESCRIPTION

A battery thermal management system is provided to improve air cooling of a multi-cell battery pack to achieve a high rate of heat rejection necessary for high power applications while maintaining a uniform cell temperature useful for maintaining and extending battery life. The battery thermal management system is used to cool and optionally heat the battery pack so as to maintain the battery pack within a desired operating temperature range and to maintain a substantially uniform cell temperature within this temperature range. This is achieved by managing an airflow throughout the battery pack based on observed temperatures of various cells of the battery pack. The battery thermal management system comprises an air supply apparatus and an electronic control unit with a memory having encoded thereon a battery temperature control logic. The air supply apparatus guides the airflow through the battery pack and the electronic control unit uses the battery temperature control logic to control airflow based on the measured temperature of the various cells of the battery pack. Additionally, the battery temperature control logic may initiate a heating source for ensuring that the battery pack temperature does not drop below a minimum temperature threshold when required.

The multi-cell battery pack can be constructed of individual cells assembled in a single unit or using a module comprising of several cells that can be used to assemble packs of various size and configuration. Depending on the cell type, system voltage and capacity requirements, packaging constraints and a number of other application factors, the configuration of modules in the battery pack can vary widely.

### Air Supply Apparatus

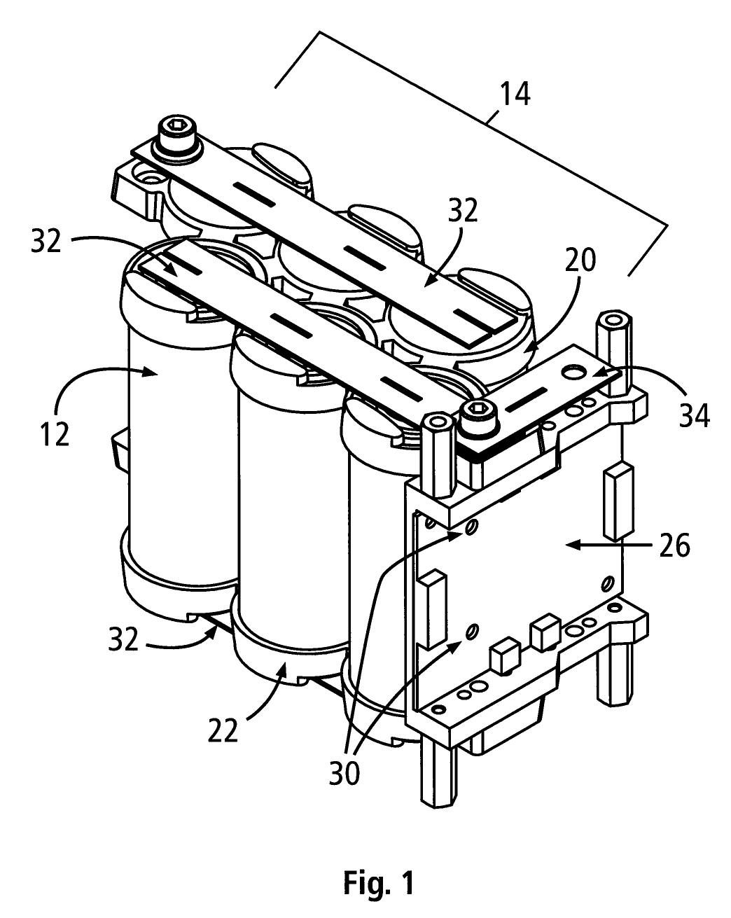

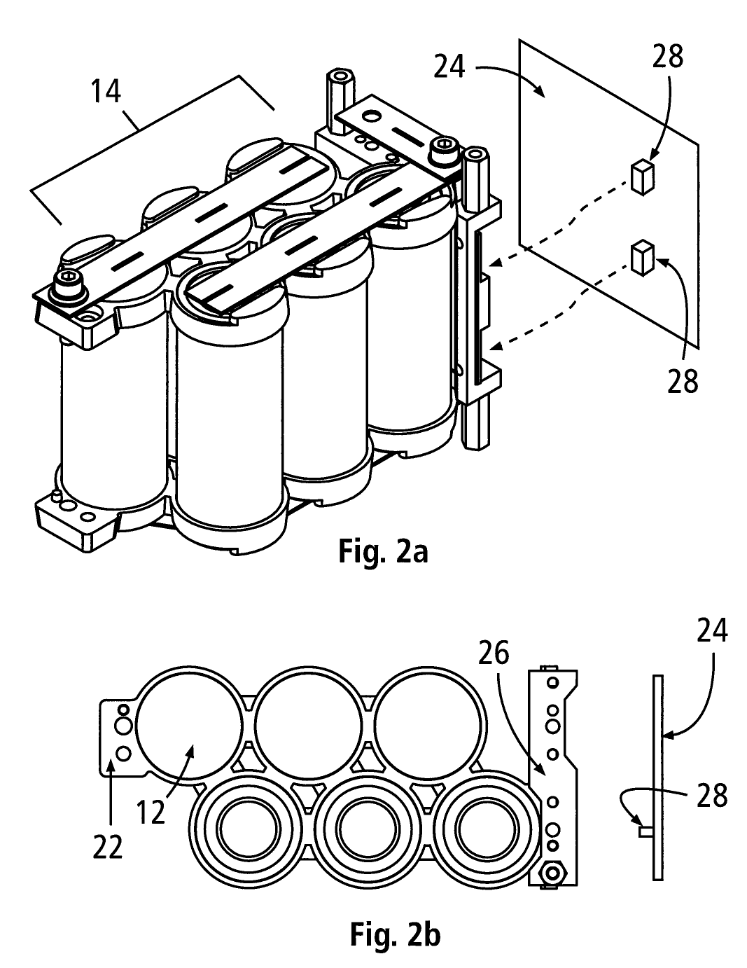

FIG. 1 shows an isometric view of an illustrative battery module shown generally at 14. Battery modules 14 are comprised of a multiplicity of cells 12 held together between a top cap 20 and a bottom cap 22. The top cap 20 and the bottom cap 22 are connected by a side plate 26 that also provides a mounting for the electronic cell management board (CMB) (not shown in FIG. 1 but shown in FIGS. 2a & 2b as element 24). The cells 12 are electrically linked together by cell connectors 32 and to other modules 14 by inter-module connectors 34.

Each module 14 is monitored for temperature by temperature sensors (not shown in FIG. 1) through sensor holes 30 in the side plate 26. The temperature measured by the sensors is relayed to electronics housed on the CMB, which is affixed to the side plate 26. Temperature fluctuations are then regulated by the electronics housed on the CMB to ensure that the battery pack temperature is substantially uniform throughout and is maintained within a desired predetermined operating parameter.

In the described illustrative embodiment, a battery pack is constructed using modules 14 comprising six lithium ion cells 12 arranged in two rows of three cells 12. Each row of three cells 12 is connected in parallel and the two sets of the cells 12 are connected in series. The cells 12 used in this system have the nominal voltage of 4.2V (fully charged) and 2.9 Ah capacity at a 1 hour discharge rate. The six-cell module 14 has nominal voltage of 8.4V and 8.7 Ah capacity. The modules 14 may be arranged into five blocks of eight modules each for a total of forty modules. That configuration results in a pack with nominal voltage of 336V at 100% state-of-charge and capacity of 8.7 Ah. The battery size is typical for an engine-dominant hybrid car or light truck with an electric motor of up to approximately 70 kW peak power. A single 2.9 Ah cell is capable of delivering peak current of up to 100 A and the full pack can deliver up to 250 A peak current. However, in actual operation, the peak loads typically do not exceed 150 A and average load is approximately 10-15 A depending on the duty cycle. The heat generated in the cell 12 during discharge and charge is primarily due to resistive losses. A smaller amount of heat is also generated or absorbed due to the enthalpy change associated with the electrochemical reaction.

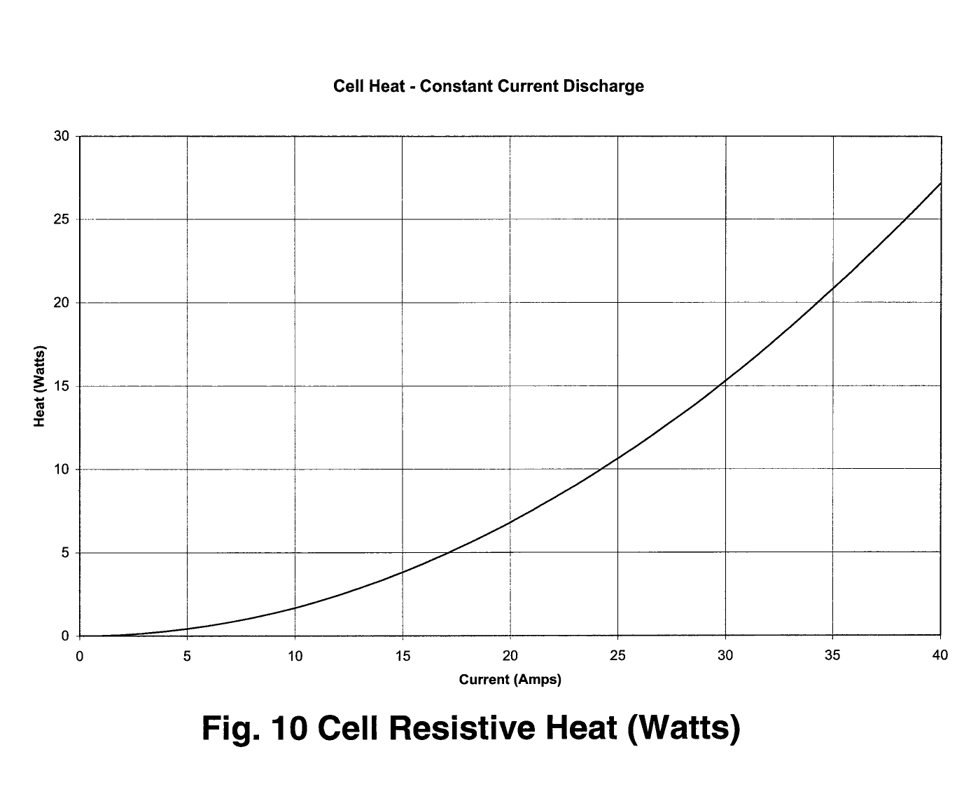

At an average load of 15 A, the battery pack generates only about 100 W of heat which can often be removed by venting. However, in heavy stop-and-go driving, the battery can generate as much as 9000 W for short periods of time, resulting in high thermal loads requiring intensive cooling. In most applications, such high thermal loads are a rare occurrence, so the cooling system can be designed for moderate loads and the thermal management system has the capability of reducing the battery output in extreme conditions. A graph of the resistive heat loss by the cell 12 as a function of discharge current is shown in FIG. 10.

FIG. 2a shows an illustrative isometric rear view of a module 14 with its CMB 24 having temperature sensors 28 which are aligned to insert through the sensor holes 30 in the side plate 26 when the CMB 24 is installed. As outlined with reference to FIG. 1, cell temperature and temperature fluctuations are detected by the sensors 28 mounted on the CMB 24.

The CMB 24 is a PCB that includes electronic components designed to measure cell voltage and temperature, convert the measured values into digital signals and transmit the data to a central BCM (not shown). The temperature sensors 28 used in the present embodiment may be of the solid state type and are attached directly to the CMB 24, for example by soldering the sensor 28 directly to the CMB. The sensors 28 are mounted in such a way that their surface contacts the cell 12. A small pad of thermally conductive material such as a Phase Change Material (PCM) may be inserted between the cell 12 and the transducer to improve the temperature reading. Other transducer types and design options can be used to measure cell temperature. For example, a thermocouple can be attached to a cell and connected to the board using wires. In the present embodiment, only the temperature of one cell in the module is measured at two locations as module tests indicated that the cell temperature is substantially uniform within the module.

FIG. 2b shows an illustrative top view of a module 14 with its top cap 20 removed to demonstrate how the temperature sensors 28 on the rear of the CMB 24 inserted through the side plate 26 are aligned to physically contact the nearest cell 12.

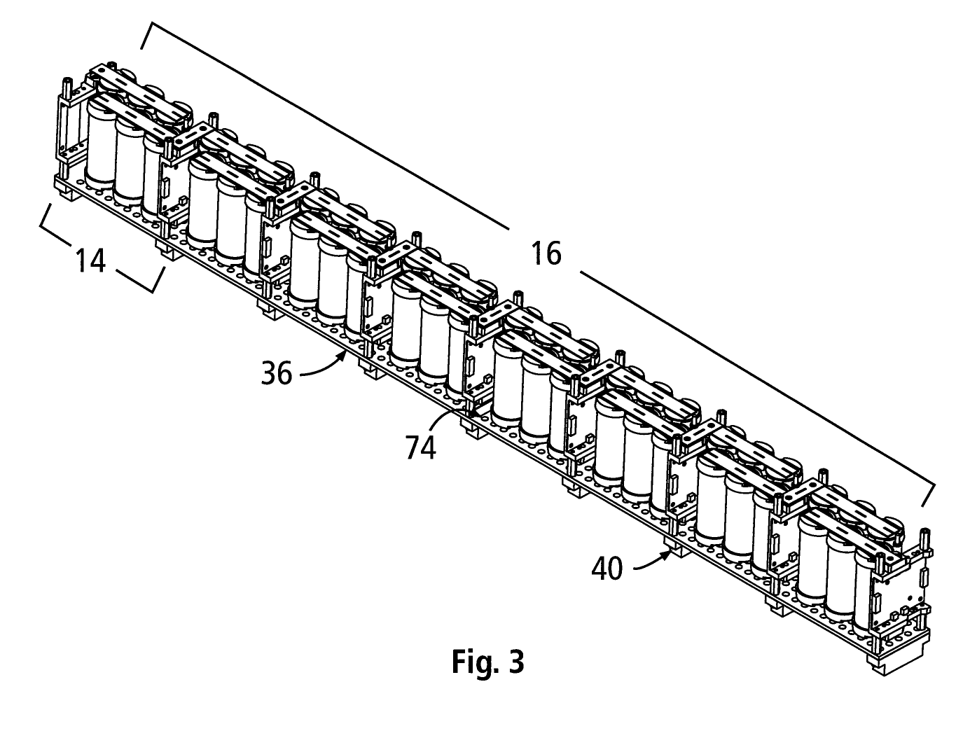

FIG. 3 shows an illustrative isometric view of a bank 16 of modules 14 supported by bottom rails 40 which support a bottom diffuser 36 with multiple airflow openings 74 therethrough. While the openings 74 in this embodiment are circular holes, other openings such as elongated slots (not shown) may be used. In order to facilitate pack assembly, the modules 14 may be assembled in sets of eight forming the bank 16. The air flow opening size and pattern varies with the pack configuration and air flow requirements.

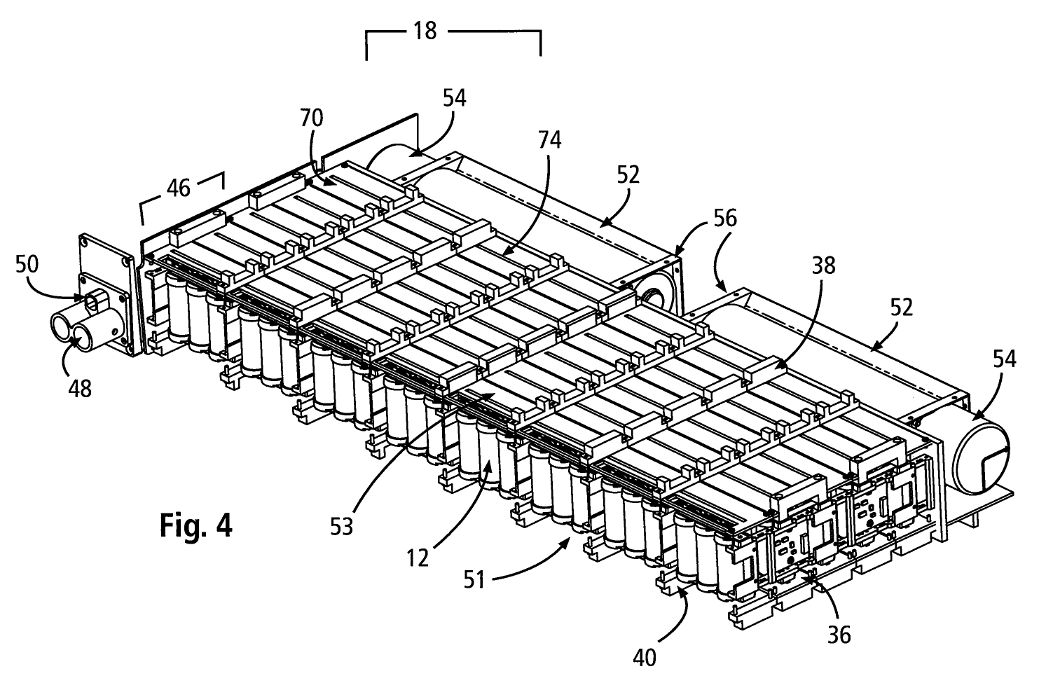

A number of banks 16 may be joined to form a battery pack 18 as shown in FIG. 4. FIG. 4 shows an illustrative isometric rear view of the pack 18 which includes a multiplicity of banks 16, CMBs 24 inserted into side plates 26, and connectors (not shown) required to supply power to the CMBs 24 and transmit signals between CMBs 24 and the BCM, all supported by bottom rails 40 and fastened together by top rails 38. Also included are a pair of fans 52 each having a motor 54 all mounted to one side of the battery pack 18 by a fan mounting 56, along with a power electronics bay 46 having power output connectors 48 and BCM interface 50.

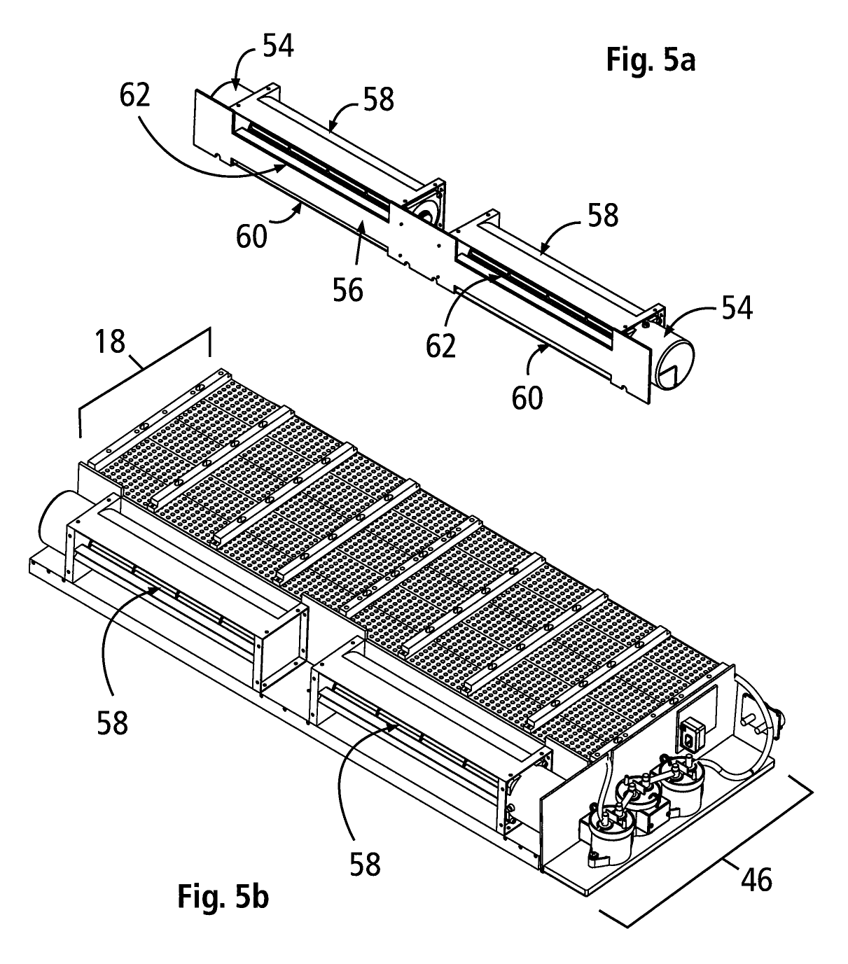

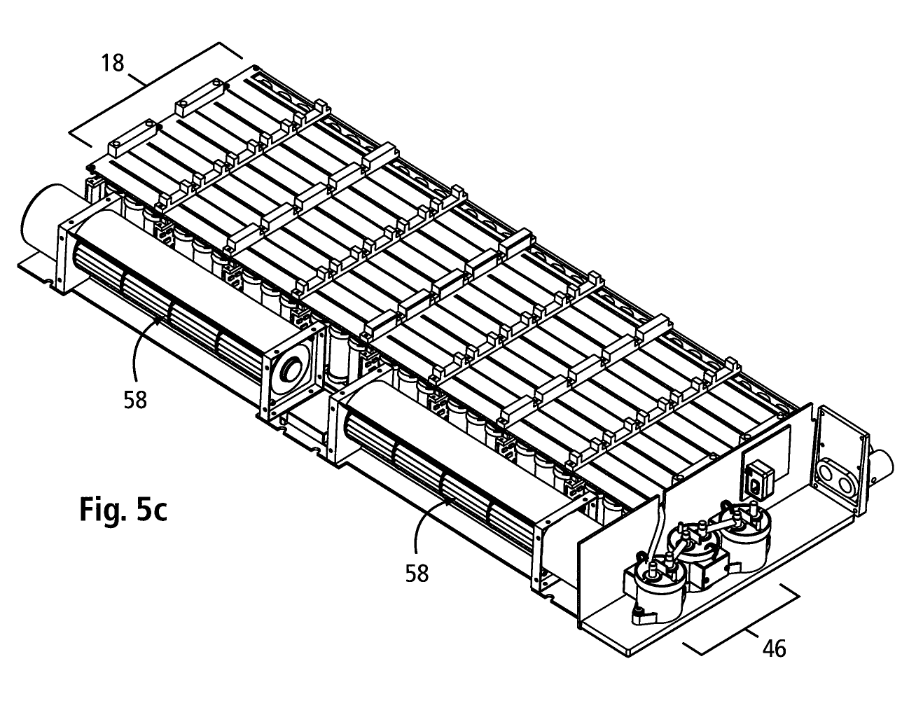

Having regard to FIGS. 5a-7b, the battery pack 18 is cooled by fans 52 installed in the battery enclosure. The fans 52 can be used either to pressurize the battery pack 18 or draw the air from the battery pack 18. Depending on the fan type and the battery pack configuration, the air pressure and velocity can vary widely across the pack 18.

Referring particularly to FIGS. 5a and 5b, the battery pack 18 includes two fans 52 of cross-flow type with a cylindrical impeller, each mounted to the rest of the battery pack 18 by a fan mounting 56. This option is preferred as this type of fan generates high flow in the form of a thin sheet of air out of outlets 60, and draws return air back into the fan through fan inlets 62. External air is drawn into the fan via fan intakes 58 on the outside of the fan housing. However other types of fans can be included in the battery management system. One illustrative fan model presently used in the pack has a maximum output of 180 cfm and requires only 24 W of power. Depending on the battery pack configuration, cell electrochemistry and the desired duty cycle, higher output fans can be used. Those skilled in the art will recognize that many different configurations of fans, blades, and impellers are possible to provide the required air flow, and further for some applications a different number of fans may be preferred and such workshop variations are within the scope of this disclosure.

When the banks 16 are joined together to form the battery pack 18, the bottom diffusers 36 of each bank 16 contact diffusers 36 of adjacent banks 16 to collectively form a bottom diffuser plate. Similarly, each bank 16 has a top diffuser 70 with multiple airflow openings 74 there-through. When the banks 16 are joined together to form the battery pack 18, the top diffusers 70 contact diffusers 70 of adjacent banks to collectively form a top diffuser plate.

The top and bottom diffusers 36, 70 sandwich the battery modules 14 there-between; the space between the top and bottom diffusers 36, 70 is hereby referred to at the battery compartment. In the embodiment shown in FIG. 4, the openings 74 in the top and bottom diffusers 36, 70 are elongated slots. However, openings of other configurations such a circular holes can be substituted.

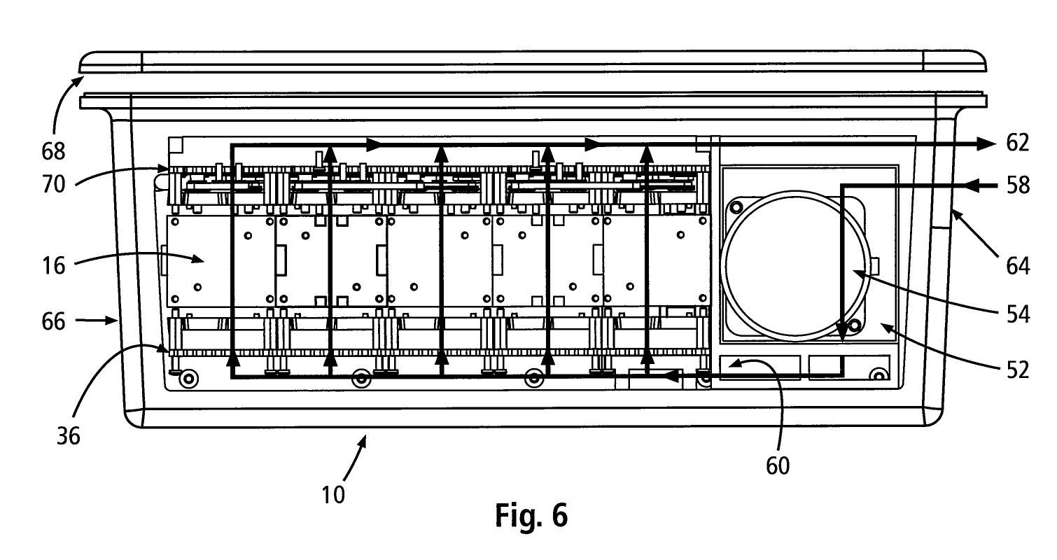

The bottom diffuser plate is mounted above a bottom plenum 51 formed below the battery pack 18. Air exhausted from the fans 52 into the plenum 51 enters the battery compartment through the openings 74 in the bottom diffuser plate (which can be referred to as the supply air diffuser). Air is discharged from battery compartment through the openings 74 in the top diffuser plate (which can thus be referred to as a discharge air diffuser). Such a configuration is shown in FIG. 6. In this FIG, the battery pack 18 is enclosed by an enclosure 66 having a removable top lid 68. Air enters the enclosure 66 through an air intake 64 vent in the part of the enclosure wall in front of each fan intake opening. The air is then impelled by the fans 52 through the fan intake 58, through fan outlet 60 into the plenum 51, up through the bottom supply air diffusers 36 into the battery compartment, upwardly across each cell 12 of each module 14 (see FIG. 3) of each bank 16 in the battery pack 18, through the top discharge air diffuser 70, then out of the enclosure 66 through fan inlet 62.

Alternatively, air may enter the battery compartment through the top diffuser plate and be discharged through the bottom diffuser plate in which case the top and bottom diffusers plates would be referred to as the supply and discharge air diffusers, respectively. Alternatively, air may be exhausted over both top and bottom diffuser plates and enter the battery compartment through openings in both diffuser plates in which case both diffuser plates are supply air diffusers.

In a conventional arrangement, cells close to a fan receive most of the air flow, while cells farther from the fan may receive little or no air flow. In order to achieve a uniform air flow through the battery compartment, the air pressure is to be maintained as uniform as possible across the surface of the battery pack 18, thereby resulting in a substantially equal air flow rate past each battery. In the present embodiment, this uniform pressure distribution is achieved by utilizing an air supply apparatus including certain features such as specifically located and shaped air flow baffles 42, 73 and diffusers 36 and 70 with openings of specifically varying size and density.

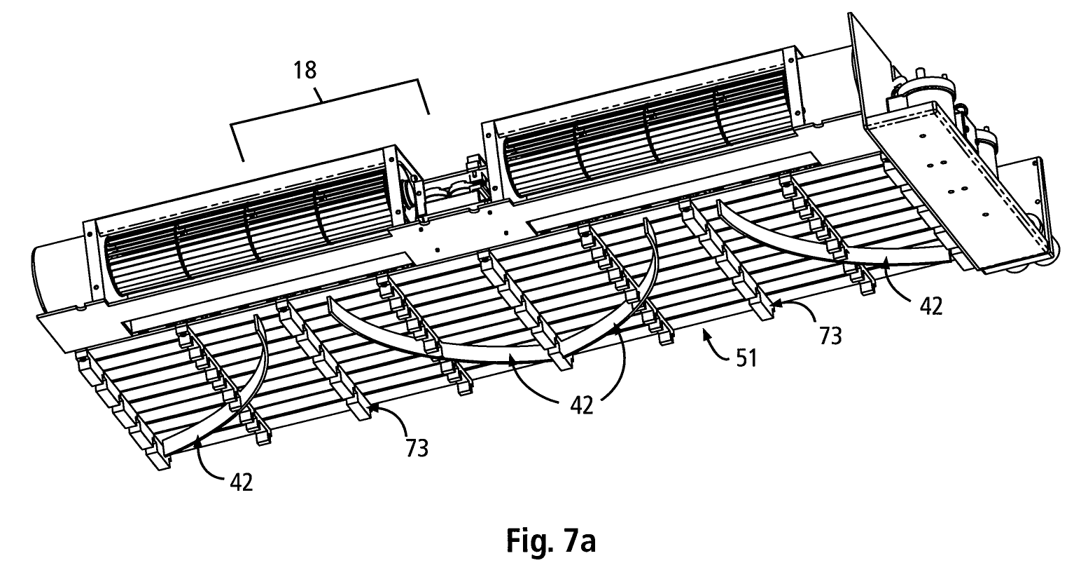

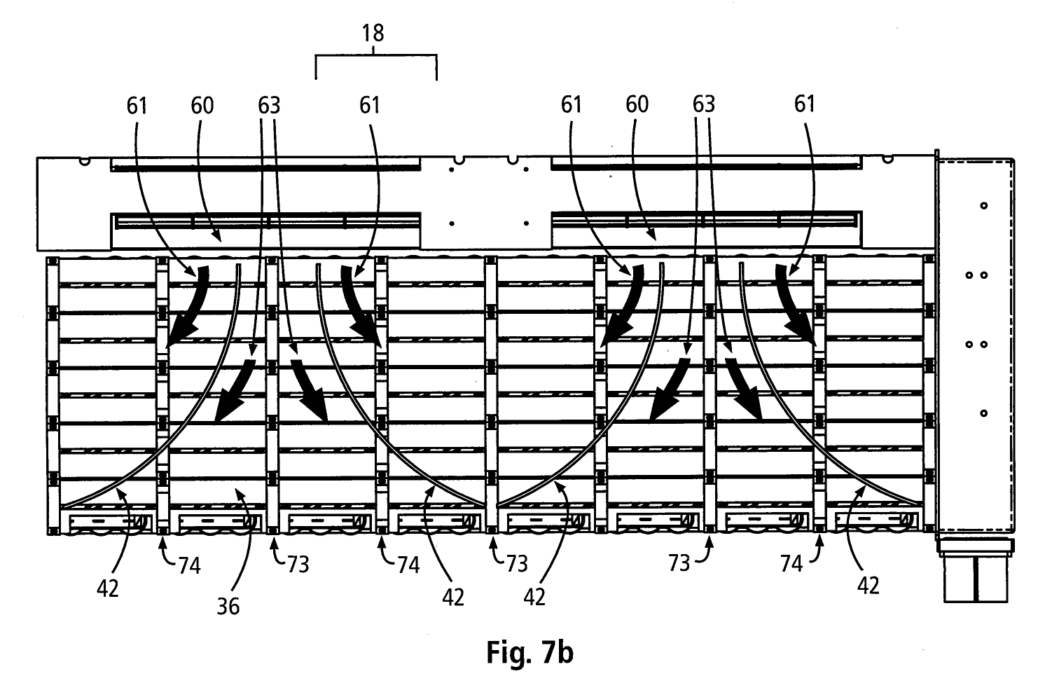

Referring now to FIGS. 7a and 7b, the bottom diffusers 36 equalize pressure distribution by redirecting some of the air flow to the areas farther from the fan outlet 60 of the fan 52. The diffusers 36 and 70 both have slots 74 positioned in such a way as to minimize flow obstructions (for instance above gaps between the cells). The diffuser openings 74 or the collective surface area of the diffuser openings 74 vary in size according to their location in the pack 18. As shown in the FIGS, the opening size of each slot 74 in the bottom diffusers 36 gradually increases with the distance the slot 74 is located from the fans 52; as the air pressure drops in the plenum 51 as a function of distance from the fans 52, the size of each opening 74 is selected to produce a uniform air flow rate across the battery pack 18. Alternatively and not shown, the openings may be a plurality of holes of the same size, wherein the density of holes increases as distance increases from the fans 52. The specific size and location of the openings is a function of the battery pack architecture. One method to determine the layout and size of the openings is to simulate air flow through the pack using Computational Fluid Dynamics software.

While both top and bottom diffusers 70, 36 are shown to have openings of varying size in this embodiment, only the air supply diffuser needs to have such openings of varying size; the air discharge diffuser can have openings of the same size. The air discharge diffuse can be just a perforated panel to provide mechanical support and allow the air the exit the battery compartment.

Alternatively, the position and size of the openings 74 can be determined by experiment by using a test box of the size of the plenum 51 with a perforated top surface. The box is pressurized using the fan intended for use with the given battery pack. The perforated surface can be masked with masking tape and the air speed can be measured with an air speed meter. The size and position of the slots 74 or holes is adjusted to obtain substantially uniform air speed across the pack. It is recommended that the total area of the openings in the diffusers should be approximately 10% larger then the fan outlet cross-section to account for pressure losses and maintain even flow.

As can be seen in FIGS. 7a and 7b, airflow baffles 42, 73 serve to distribute the air evenly through the plenum 51 underneath the cell assembly. A “baffle” as used herein is a structure or structures working alone or together to impede, enhance or otherwise alter the pattern, direction, or velocity of the airflow throughout the battery pack 18. In this case, the baffles comprise curved partitions 42 and straight partitions 73 which also act as diffuser supports. Of note are diffuser supports 74 which have large cut-outs in order to be relatively transparent to the air flow, and do not serve as baffles. The arrows in FIG. 7b illustrate how the baffles 42, 73 redirect airflow from the fan outlets 60 to the openings 74 in the bottom diffuser plate. Those of ordinary skill in the art will recognize that changes to the baffles 42, 73, including but not limited to changes to the size, shape, position, number of walls, and types of walls will all affect the characteristics of the air flow. A desired flow pattern may be designed by altering one or more of the baffle characteristics, e.g. layout, shape, size, texture.

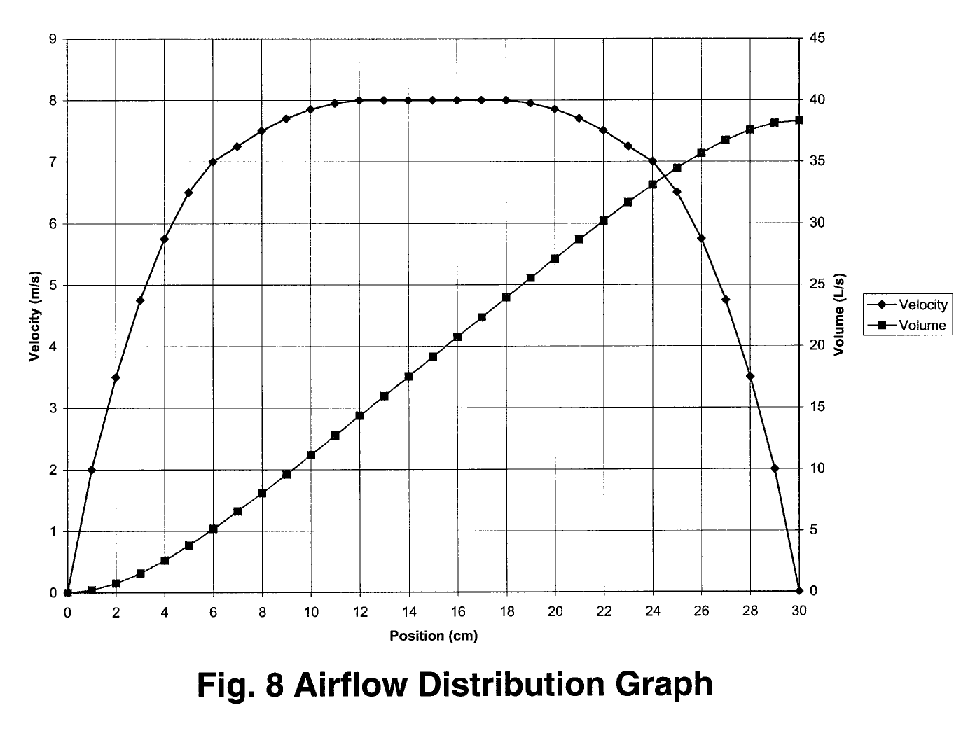

The baffle 42, 73 characteristics are dictated by the characteristics of the air flow discharged from the fan 52. Referring to FIG. 8, the velocity distribution of the air flowing out of the fan 52 is not uniform across each fan outlet 60. The air flow is generally lower at the edges of the outlet 60 and higher at its center. Consequently and as can be seen in FIG. 7b, partitions comprising the baffles 42, 73 are located in front of each fan outlet 60 in such a way as to divide the plenum 51 into separate sections; the shape and location of the baffles 42, 73 are selected to ensure that each plenum section receives a substantially equal amount of air. The leading edges of each baffle 42, 73 are mounted in the plenum 51 such that the outlet 60 of each fan 52 is divided into four sections of approximately equal air flux (i.e. flow rate of area per unit area). The location of each of the leading edge of the baffles 42, 73 is determined by mapping the air flow velocity at each widthwise location along the outlet 60, then integrating the velocity curve to obtain the total air flow as a function of the distance from the edge of the fan outlet 60. Dividing the total air flow by four provides the target air flow for each section.

It is noted in this embodiment, that the total plenum width is greater than the total width of the two fans outlets 60; in this case, the width of half of the plenum 51 is 40 cm and the width of each fan outlet is 30 cm. The outside edge of each outlet 60 is about 5 cm from the respective edges of the plenum 51. The total air flow across the entire outlet 60 is about 38 L/s. Therefore, the air flow for each of the sections should be about 9.5 L/s. Reference to FIG. 8 shows that the baffles 42, 73 leading edges should therefore be located at 14 cm, 20 cm and 28 cm from the left edge of the plenum 51.

Air discharged from each outlet 60 is directed into four streams 61, 63 by the respective baffles 42, 73. The two outer streams 61 and the two inner streams 63 have substantially the same flow pattern. As the four air streams 61 and 63 from the fan outlet 60 have different widths (in this case 9, 6, 6 and 9 cm) and velocities, but substantially equal air flux, the plenum area supplied by each fan outlet is divided by the baffles 42, 73 into four sections of the same area but having different shapes.

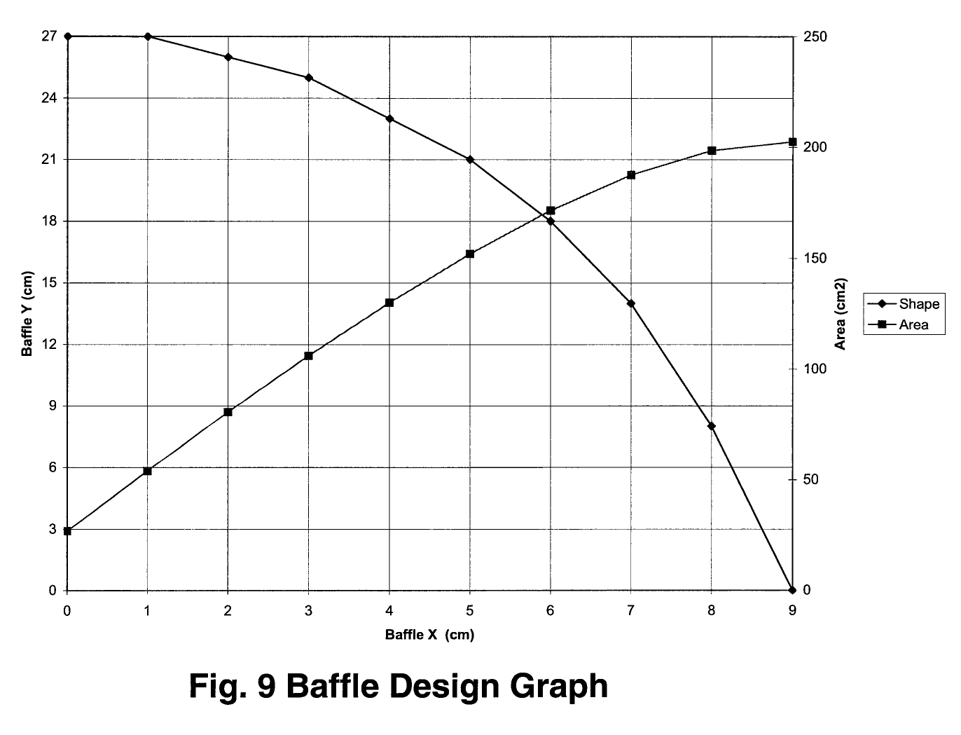

The placement and shape of the baffles 42, 73 should be such that the plenum sections supplied by each air stream 61 and 63 are approximately equal as each air stream 61 and 63 is substantially equal in flow volume. This can be achieved by entering the baffle shape data into a spreadsheet and integrating the data to obtain the area under the curve. This is shown in FIG. 9.

In this embodiment, as the air flow exhausted from the fan outlet 60 is divided into four air streams 61 and 63, the calculated area should be equal to ¼ of the total area of the plenum 51. In the case presented in FIG. 9, the dimensions of the plenum area per fan (half plenum) are 40 by 27 cm resulting in the total area of 1080 cm². As such, each air flow division should supply an area of 270 cm². To accomplish this, the partitions 42, 73, should divide the plenum 51 into four areas of 270 cm² and guide each of the air streams 61, 63 to one of the areas of the half plenum. This is done using a center internal baffle 73 which divides the exhausted air flow into two flows which each supply an area of 540 cm². The side baffles 42 are curved and divide each half of the half plenum into two sections of 270 cm² supplied by each of the two flows. FIG. 9 shows the baffle curvature as a function of the fan outlet width and the resulting area graph. It is possible to use more than three partitions 42, 73 to improve air distribution. The curvature of each baffle 42 can be modified until desired area divisions are achieved.

The aforementioned fan outlet 60 and partitions 42, 73 ensure that the air flow is evenly distributed throughout the plenum 51 without “dead spots”. However, the pressure distribution within the plenum 51 is not uniform. It is highest in close proximity to the fan outlet 60 and decreases with the distance from the fan outlet 60. If the pressure distribution is not compensated for, the air flows through the shortest path directly at the fan outlet 60, with the majority of the cell assembly not receiving any cooling. In order to ensure equal flow through the pack 18, the bottom diffusers 36 are mounted above the plenum 51 having the opening pattern as previously discussed. The top diffusers 70 can also be provided with the same opening pattern for discharging air from the battery pack 18 (or alternatively serving as a supply air diffuser and receiving air from the fan outlet 60).

In one embodiment, the cooling air flows out of the plenum 51 through the diffuser 36 into the battery compartment and through the diffuser 70 and exits the battery enclosure through vents or air ducts if the battery is installed inside the vehicle. To maximize cooling efficiency and ensure uniform cell temperature, the flow path through the cell assembly may be optimized. The optimized path is determined by the cell arrangement and the spacing between the cells 12 of the battery pack 18. The air flow through the pack 18 can be either in the direction parallel to the cell axis (axial flow) or perpendicular to the cell axis (cross-flow). Axial airflow yields the most uniform heat transfer conditions if the cells are arranged in a single layer. If there is more than one layer of cells, the axial flow results in uneven cooling of the cells as the downstream cells receive less airflow than the upstream cells. Cross-flow cooling requires airflow perpendicular to the cell axis, and also results in uneven cooling of each cell 12, because each exposed side has a higher heat transfer rate than its back side. Another drawback of cross-flow cooling is that airflow is significantly obstructed by multiple layers of cells 12, resulting in increased pressure drop causing higher fan power demand and operating noise.

The arrangement of the cells 12 in the module is such that the air can flow freely through the pack 18 around the cells 12. The cells 12 are arranged in a single layer as shown in FIGS. 1-4. The air flows between the cells 12 parallel to the cell axes. The spacing between the cells 12 must be sufficient to allow the air flow. However, due to the cylindrical cell shape, even when the cells 12 are tightly packaged there is sufficient cross sectional area for air to flow. The cell spacing is more of a packaging design issue than air flow issue as the space is typically significantly larger than the fan intake area. It is preferred that the cells 12 are somewhat separated to improve heat transfer from the cell 12 to the cooling air. In the present illustrative embodiment, the minimum distance between the cells 12 is 2 mm.

### Battery Temperature Control Logic

In the present embodiment, an electronic control unit is used to control the air supply and ensure that the cells 12 remain within a predetermined allowable temperature range. The control unit has encoded thereon a battery temperature control logic for the battery pack 18. This control logic in conjunction with the air supply apparatus form the battery thermal management system. The battery temperature control logic of the battery thermal management system has two objectives. First, to detect potential overheating of the cell and second, to manage the air flow to remove the heat from the cells 12 in order to maintain the cell temperature within a selected temperature range or alternatively to manage the heating of the battery pack 18. Additionally, the battery temperature control logic may further detect if the cell 12 is too cold and initiate a heating pad to heat the battery pack 18. This will be discussed in more detail below.

As shown in FIGS. 2a & 2b and 11, each module 14 has sensors 28 that measure the temperature of the nearest cell 12 and communicate to the CMB 24. The temperature data is measured and converted for digital transmission by an electronic circuit on the CMB 24 mounted on each module 14. The temperature data is then transmitted via a data bus, such as a Controller Area Network (CAN), to an external central processing unit or electronic control unit (ECU) 80 referred to as a BCM 80 via an ECU interface 50 (shown in FIG. 4). The BCM 80 has a memory with the battery temperature control logic encoded thereon. In accordance with this logic, the BCM 80 controls the fans 52 based on the temperature and current data received from the CMBs 24, which monitors the temperature of each module 14 and determines if the temperature value falls within the allowable operating temperature range. If the measured temperature value exceeds the allowable limit, the BCM 80 shuts down the system by opening power contactors 82 that connect the battery to the vehicle motor controller and other vehicle systems requiring high voltage (not shown). In the present embodiment, the cut-off temperature for the lithium-ion cells is about 60° C. As an added safety measure, the BCM 80 may evaluate performance of the thermal management system. If a condition is detected when the battery temperature is increasing despite the fans 52 operating at maximum settings, the BCM 80 may send a signal to the vehicle control system to reduce the load on the battery. The maximum power allowable from the battery is programmed into the BCM software. This value is reduced if the above overheating condition is detected. For example, in the present embodiment, the maximum allowable power is reduced by 10 kW every one minute until the battery temperature stabilizes.

The temperature data may also be used to detect possible cell damage. The BCM software is calibrated to include a map of the typical cell temperature distribution across the pack. The BCM 80 compares the measured battery temperatures to the temperatures indicated by the pre-programmed map. The data is normalized to compensate for pack temperature level by referring each module temperature to the temperature of a reference module. In the present embodiment, the reference module is a module in the centre of the pack 18. If a module or a set of modules consistently shows temperature higher or lower than predicted, it indicates a potential cell 12 or module failure and the BCM 80 generates a warning message that is communicated to the vehicle diagnostics system.

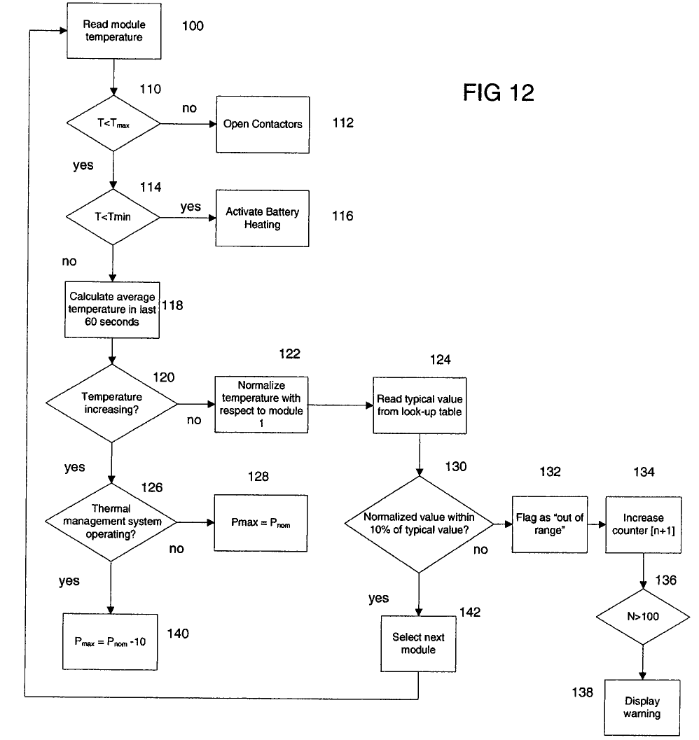

The BCM logic to implement the temperature limits and assess cell temperature uniformity is shown in FIG. 12. First, the temperature T of a subject module is read (step 100). The measured temperature is compared to a maximum temperature set point Tₘₐₓ (step 110); when the measured temperature is greater than this set point, then the BCM opens contactors (step 112) and when the temperature is less than a minimum temperature set point Tₘᵢₙ (step 114), then the BCM 80 activates battery heating (step 116). When the measured temperature is within the allowable limits, the BCM 80 calculates the average temperature in the last 60 seconds (step 118). When the temperature has been found to be increasing (step 120), the BCM 80 checks if the thermal management system (TMS) is operating (step 126). If the TMS is off, the BCM 80 does not take any action and the allowable charge and discharge power limit Pₘₐₓ remains equal to the nominal value Pₙₒₘ determined from the battery characteristics pre-programmed in the control software for given state of charge and temperature conditions (step 128). However, if the battery temperature is increasing and the TMS is operating, the BCM 80 reduces the charge and discharge power limit Pₘₐₓ by a prescribed amount, in this case 10 kW (step 140). The process is repeated every 60 seconds. The recommended temperature sampling period is 1-5 seconds.

If the average temperature of the battery is found to be steady or decreasing, the BCM 80 performs a check of temperature uniformity across the battery pack 18. In order to evaluate the temperature differences between the modules 14, the BCM 80 normalizes the temperature with respect to the subject module 14 (step 122), then reads a typical temperature value from a look up table (step 124). If the normalized temperature value is within 10% of the typical temperature value, then the BCM 80 proceeds to the next module 14 (step 142) and restarts the process. When the normalized temperature is outside the 10% range, the BCM 80 flags this module 14 as “out of range” (step 132) and increases a counter by 1 (step 134). The BCM 80 continues to test all the modules 14 and continues to increase the counter by 1 when the normalized temperature for a tested module 14 is out of range. When the counter value for a given module 14 exceeds a prescribed limit, in this case 100 (step 136), then a warning is displayed 138. The warning indicates that the module 14 is consistently warmer or colder than expected and the pack should be inspected for potential cooling or charge balancing problems.

The second function of the battery temperature control logic is to control the fans 52. In order to remove the heat generated by the cells 12, the air flow through the pack 18 must be sufficient to allow the entire heat from the batteries to be transferred to the air, given cell-to-air heat transfer characteristics and ambient temperature conditions. To achieve maximum battery life, it is desired to maintain the battery temperature within a narrow temperature range.

A conventional approach to control the battery temperature is to turn the fans 52 on when the battery temperature reaches a predetermined threshold and turn them off when the battery returns to the desired operating temperature. This approach requires high air flow as the amount of heat to be removed is proportional to the battery temperature.

However, temperature control may be improved by active fan management using the battery load energy as a reference variable rather than direct temperature. This is achieved by measuring the load current and calculating the energy flowing from and to the battery. The calculations use the cell internal resistance and current to calculate the resistive heat generated by the battery. The total heat generated by the cell includes the resistive heat and the heat due to enthalpy change. The formula to calculate the heat generated by the cell is:

Q=I²*R+Qₑ, [eq. 1]

where: Q—total heat generated by the battery,

I—battery current

R—battery internal resistance

Qₑ—heat generated or absorbed due to enthalpy change.

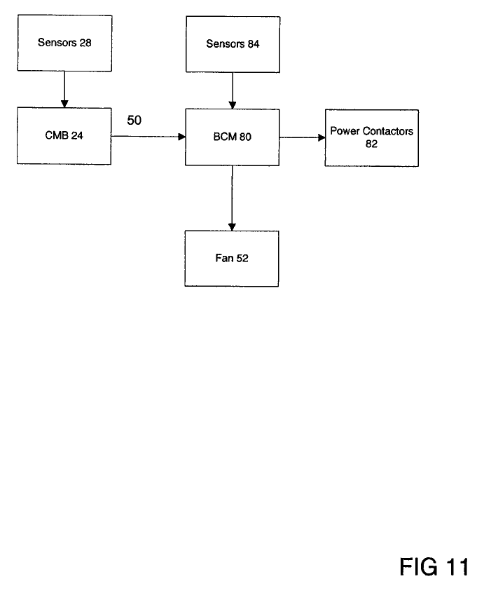

Referring again to FIG. 11, the current is measured directly using a current sensor 84 mounted in the battery pack 18. The sensor 84 generates a voltage signal proportional to the current flowing to and from the battery. The voltage signal is read by the BCM 80 which calculates the battery current using scaling factors specific for the transducer. In the present embodiment, a Hall effect current sensor is used. The battery internal resistance and the enthalpy change heat characteristics are implemented in the BCM control software in the form of tables as a function of the state of charge of the battery. The instantaneous energy delivered to or removed from the battery is calculated according with the above formula in, for example, one second intervals and integrated to obtain the total energy exchanged with the battery. The BCM control software includes a look up table that provides the data on the maximum energy level at which the battery remains in thermal balance at a given temperature without forced cooling. If the value is exceeded, the fans 52 are activated until the energy criterion drops below a prescribed limit. The described embodiment uses constant speed fans that generate constant air flow. However, variable speed fans can also be implemented, where the fan speed is controlled in accordance with the calculated battery load.

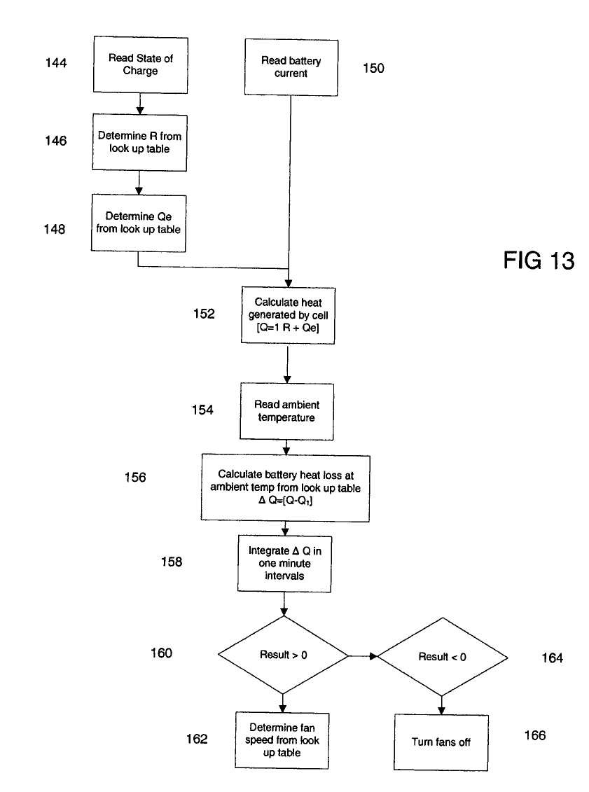

The BCM logic required to control the air flow using the above described energy criterion is shown in FIG. 13. First, the BCM 80 reads the state of charge (SOC) (step 144) and battery current (step 150), then determines the R and Qₑ values from a look up table (steps 146,148). With these values, the BCM 80 calculates the heat generated by the cell according to equation 1 (step 152). Then, the BCM 80 measures the ambient temperature (step 154) and calculates battery heat loss at ambient temperature from a look up table (step 156). The battery heat loss is integrated at one minute intervals (step 158) and if the result is greater than 0 (step 160) then the fan speed is determined from a look up table (step 162). If the result is less than 0 (step 164), then the fans 52 are turned off.

The following additional embodiments, or similar methods leading to the same result, are not ruled out. A thermal management system should adapt to all environmental conditions. While the battery pack 18 is operating, the object is to efficiently maintain optimal cell 12 operating temperatures. However, when the battery pack 18 is inactive, a means to prevent the cells 12 from becoming too cold to function must be considered. A heating pad (not shown) in the bottom of, or underneath, the enclosure 66 to keep the central core of the battery pack 18 warm enough during periods of low temperature inactivity can be used. This is accomplished by implementing a wake-up mode of the BCM 80, where the BCM 80 is automatically activated, for example, every one hour, when the vehicle is inactive to check the status of the system. If the battery temperature drops below, for example, 0° C., the heating pad is activated until next status check. In the event of extended inactivity, this is maintained until the battery state-of-charge drops below a minimum threshold, for example 20%, when the system shuts down. Also, a means to automatically block the air intake 64 to prevent cold air from entering the enclosure 66 during battery pack 18 inactivity may be employed.

Illustrative materials for constructing major elements of the thermal management system are mentioned herein. The enclosure 66 and its lid 68 may be molded of carbon fiber. The module's 14 mounting plate 26, top cap 20 and bottom cap 22 may be polyethylene. Cells 12 may be lithium based chemistry, with this embodiment utilizing a manganese dioxide positive electrode with a graphitic carbon negative electrode. The diffusers may be made of polyvinyl chloride (PVC). The rails 38 and 40, baffles 42, the structure of the fan mounting 56 and the electronics bay 46 may all be made of plastic. The fan 52 may include an aluminum motor 54 and impeller with a steel casing. All electrical connectors may be made of a non-corrosive conductor such as nickel-plated copper, and fasteners are made of stainless steel.

The present invention has been described with regard to a plurality of illustrative embodiments. However, it will be apparent to persons skilled in the art that a number of variations and modifications can be made without departing from the scope of the invention as defined in the claims.

1. A battery thermal management system for managing the temperature of a battery pack in a hybrid vehicle, comprising:
(a) a battery pack;
(b) a fan having an air outlet; and
(c) a plenum having an inlet in fluid communication with the fan air outlet, and a supply air diffuser in fluid communication with the battery pack, the supply air diffuser having openings configured to deliver a substantially uniform air flow across the battery pack from an air flow supplied by the fan to the plenum.

2. A battery thermal management system as claimed in claim 1 wherein the plenum further comprises at least one baffle extending from the fan air outlet and across the supply air diffuser in such a configuration that the plenum is divided into multiple sections receiving substantially equal air flux from the fan.

3. A battery thermal management system as claimed in claim 1 wherein the diffuser openings are slots of increasing size with increasing distance from the fan air outlet.

4. A battery thermal management system as claimed in claim 1 wherein the diffuser openings are holes with one or both of increasing density and increasing size with increasing distance from the fan air outlet.

5. A battery thermal management system as claimed in claim 1, further comprising multiple baffles and wherein the fan air outlet has a rectangular cross-section and the leading edges of the baffles are concentrated around the centre of the fan air outlet.

6. A battery thermal management system as claimed in claim 5, further comprising three baffles per fan air outlet, wherein a centre baffle is straight and has a leading edge at the centre of the fan outlet and the other two baffles are respectively located on either side of the centre baffle and each have a trailing edge that curves away from the centre baffle.

7. A battery thermal management system as claimed in claim 1, further comprising a discharge air diffuser having openings in fluid communication with the battery pack, the supply air diffuser and discharge air diffuser are spaced from each other to form a battery compartment therebetween, and the battery pack is located inside the battery compartment.

8. A battery thermal management system as claimed in claim 7 wherein the discharge air diffuser openings are slots of increasing size with increasing distance away from the fan air outlet.

9. A battery thermal management system as claimed in claim 7 wherein the discharge air diffuser openings are holes with one or both of increasing density and increasing size with increasing distance away from the fan air outlet.

10. A battery thermal management system as claimed in claim 1 wherein the battery pack is comprised of a plurality of modules and temperature and current sensors, each module comprising a plurality of electronically linked cells and wherein the temperature of at least one cell from each module is monitored by the sensors.

11. A battery thermal management system as claimed in claim 10, further comprising:
a cell management board (CMB) communicative with the sensors; and
an electronic control unit communicative with the CMB and the fan and operable to control the operation of the fan based on temperature and current data received from the CMB.

12. A battery thermal management system as claimed in claim 11 wherein the electronic control unit has a memory having code recorded thereon for execution by the control unit, the code comprising a map of a typical cell temperature distribution encoded thereon, a step for comparing temperatures measured by the sensors with temperatures in the map, and a step for generating a warning message when the measured temperatures differ by a selected threshold from the temperatures in the map.

13. A battery thermal management system as claimed in claim 12, further comprising power contactors electrically connected to the battery pack and for electrically connecting to a vehicle motor controller, and wherein the electronic control unit is communicative with the power contactors and the code includes a step for opening the power contactors when temperature measured by the sensors exceed a selected threshold.

14. A battery thermal management system as claimed in claim 13, further comprising a heater in communication with the electronic control unit, and the code includes a minimum battery pack temperature threshold, and a step for activating the heater to maintain the temperature of the battery pack above the minimum battery pack temperature threshold based on the temperature signals received from the sensors.

15. A computer readable memory having recorded thereon code for execution by an electronic control unit of a battery thermal management system, to carry out a method comprising:
measuring the temperature of at least one module of a battery pack; and
when the measured temperature is within a predefined range and increasing, reducing charge and discharging power limit of the battery pack by a prescribed amount.

16. A memory as claimed in claim 15 wherein the method comprises when the measured temperature is steady or decreasing, comparing the measured temperature of multiple modules of the battery pack with temperatures in a map of a typical cell temperature distribution, and generating a warning message when the measured temperatures differ by a selected threshold from the temperatures in the map.

17. A memory as claimed in claim 16 wherein the method further comprises opening a power contactor electrically connected to the battery pack and electrically connected to a vehicle motor controller when closed, when the measured temperature exceeds the predefined range.

18. A memory as claimed in claim 16 wherein the method further comprises activating a battery heater when the measured temperature falls below the predefined range.

19. A memory as claimed in claim 16 wherein the method further comprises
reading a state of charge and battery current of a battery cell in the battery pack;
determining a battery internal resistance and heat generated or absorbed by the battery cell due to enthalpy change,
calculating heat Q generated by the battery cell according to formula:
Q=I²*R+Qₑ,
wherein: I=battery current;
R =battery internal resistance; and
measuring ambient temperature;
calculating battery heat loss at the ambient temperature; and
integrating the battery heat loss at periodic intervals and setting a fan at a selected speed when the integrated battery heat loss is greater than 0, and turning off the fan when the integrated battery heat loss is less than 0, the fan being in air communication with the battery pack.
